(19) United States
(12) Patent Application Publication
(10) Pub. No.: US 2001/0044904 A1
(43) Pub. Date: Nov. 22, 2001

(54) Secure remote kernel communication

(76) Inventors: Ryan J. Berg, Marlborough, MA (US); John J. Danahy, Canton, MA (US); Lawrence J. Rose, Chelmsford, MA (US)

Correspondence Address: RICHARD L. SAMPSON, SAMPSON & ASSOCIATES, 50 CONGRESS STREET, BOSTON, MA, 02109, US

(21) Appl. No.: 09/784,960

(22) Filed: Feb. 15, 2001

Related U.S. Application Data
(63) Continuation-in-part of application No. 09/625,299, filed on Jul. 25, 2000.
(60) Provisional application No. 60/156,671, filed on Sep. 29, 1999.
(60) Provisional application No. 60/182,743, filed on Feb. 16, 2000.
(60) Provisional application No. 60/186,781, filed on Mar. 3, 2000.

(51) Int. Cl. H04L 9/32; H04L 9/00

(52) U.S. Cl. 713/201; 713/164

(57) ABSTRACT

A remote communication mechanism is provided for creating a secured channel for direct interaction with kernel-level components, such as device drivers, of designated systems. By connecting directly to managed kernel-level devices, as opposed to connecting to user space software which then connects to these devices, management of those resources is simplified, better secured, and partitioned from general system administration utilities and configuration.

### RELATED APPLICATIONS

This application claims priority to U.S. Provisional Patent Application Ser. No. 60/156,671 entitled Intrusion Protection For Computer Systems, filed Sep. 29, 1999; to U.S. Provisional Patent Application Ser. No. 60/182,743 entitled Computer Security Using Dual Functional Contexts, filed Feb. 16, 2000; and to U.S. Provisional Patent Application Ser. No. 06/186,781 entitled Secure Remote Kernel Communication, filed Mar. 3, 2000. This application is a Continuation-In-Part of U.S. patent application Ser. No. 09/625,299 entitled Computer Security Using Dual Functional Security Contexts, filed Jul. 25, 2000.

### BACKGROUND OF THE INVENTION

1. Technical Field

This invention relates to computer security, and more particularly to a system and method for providing secure communication with directly with kernel-level components of a computer system.

2. Background Information

The concept of remote communication to computer systems has been well established over the past thirty years. Beginning with terminal servers utilizing simple hardwired networks to allow data input and output, and evolving to today's pervasive Internet connectivity, organizations have long recognized the need to access systems and system resources from remote locations. Common to these environments, however, has been the distinction between the origination location of the communication and the ultimate destination of that remote communication traffic. A very simple example is the model used by email routines, existing remote session utilities, and remote system management tools. In each and every one of these circumstances, a user-space process on the destination machine, one that authorizes the remote access and then actually translates the remote commands into local action, brokers the remote connection. In so doing, the brokering application must, itself, be subject to protections and network configurations that are created for the system as a whole. This creates a potential security exposure, since without additional hardening, the application-level administrative control functions of this application may be suborned, or otherwise compromised, thereby providing unauthorized access. As a result, it is necessary to define a new method of remote communications that can ensure resource protection while facilitating remote management.

### SUMMARY

An embodiment of this invention includes a method of providing secure communication with kernel-level components of a computer system having an operating system that includes user space and kernel space. The method includes the step of locating an authentication module in the kernel space, in communicably coupled relation with the kernel-level components, to selectively encrypt and decrypt communications between the kernel-level components and a remote site. The method also includes locating a transport module in the kernel space, in communicably coupled relation with the authentication module, to selectively transmit and receive the communications. The authentication module and the transport module are selectively actuated to convey the communications to and from the kernel-level components.

An alternate embodiment of the present invention includes a method of providing secure communication with kernel-level components of a computer system having an operating system that includes user space and kernel space. This method includes the step of locating a filter driver in the kernel space to selectively permit and prevent communications with the kernel-level components. In addition, an authentication module is placed in the kernel space, in communicably coupled relation with the filter driver, to selectively encrypt and decrypt the communications. The method further includes placing a transport module in the kernel space, in communicably coupled relation with the authentication module, to selectively transmit and receive the communications. The filter driver, authentication module, and transport module are actuated to respectively convey received and transmitted communications to and from the kernel-level components.

In an alternate embodiment, a system is provided for securing communication between a remote site and kernel-level components of a computer having user space and kernel space. The system includes a filter driver located in the kernel space to selectively permit and prevent communications with the kernel-level components. An authentication module is also located in the kernel space, in communicably coupled relation with the filter driver, to selectively encrypt and decrypt the communications. In addition, a transport module is located in the kernel space, in communicably coupled relation with the authentication module, to selectively transmit and receive the communications. A remote authentication module is located in the remote site, in communicably coupled relation with the transport module, to selectively decrypt and encrypt the communications in cooperation with the authentication module. During operation of the system, communications from the remote site to the kernel-level components are sequentially encrypted by the remote authentication module, received by the transport module, decrypted by the authentication module, and selectively permitted to reach the kernel-level components by the filter driver. Similarly, communications generated by the kernel-level components are sequentially permitted by the filter driver, encrypted by the authentication module, transmitted by the transport module, and decrypted by the remote authentication module.

A further embodiment of the present invention includes an article of manufacture for providing secure communications with kernel-level components of a computer system having an operating system that includes user space and kernel space. The article of manufacture includes a computer usable medium having computer readable program code embodied therein, the computer usable medium having computer readable program code for defining an authentication module in the kernel space, in communicably coupled relation with the kernel-level components, to selectively encrypt and decrypt communications between the kernel-level components and a remote site. Computer readable program code is also provided for defining a transport module in the kernel space, in communicably coupled relation with the authentication module, to selectively transmit and receive the communications. The article of manufacture also includes computer readable program code for selectively actuating the authentication module and the transport module to convey the communications to and from the kernel-level components.

In a still further embodiment, the present invention includes computer readable program code for providing secure communications with kernel-level components of a computer system having an operating system that includes user space and kernel space. The computer readable program code includes computer readable program code for defining an authentication module in the kernel space, in communicably coupled relation with the kernel-level components, to selectively encrypt and decrypt communications between the kernel-level components and a remote site. Computer readable program code is also provided for defining a transport module in the kernel space, in communicably coupled relation with the authentication module, to selectively transmit and receive the communications. In addition, computer readable program code is provided for selectively actuating the authentication module and the transport module to convey the communications to and from the kernel-level components.

### BRIEF DESCRIPTION OF THE DRAWINGS

The above and other features and advantages of this invention will be more readily apparent from a reading of the following detailed description of various aspects of the invention taken in conjunction with the accompanying drawings, in which:

FIG. 1A is functional block diagram including a kernel-communication system of the present invention;

FIG. 1B is a block diagram of a host system incorporating the kernel-communication system of FIG. 1A into a computer security system;

FIG. 2 is a block diagram, at a generally higher level, of the computer security system of FIG. 1B;

FIG. 3 is a block diagram, in greater detail, of various components of the computer security system of FIG. 2;

FIG. 4 is a functional block diagram of operation of various components of the computer security system of FIGS. 1-3;

FIG. 5 is flow chart of various operations of the computer security system of FIGS. 1B-4;

FIG. 6 is a block diagrammatic representation of a data packet generated by the computer security system of FIGS. 1-5;

FIG. 7 is a block diagrammatic representation of an IRP path of the prior art; and

FIG. 8 is a view similar to that of FIG. 7, of an IRP path of a host system incorporating the computer security system of the present invention.

### DETAILED DESCRIPTION

Referring to the figures set forth in the accompanying drawings, the illustrative embodiments of the present invention will be described in detail hereinbelow. For clarity of exposition, like features shown in the accompanying drawings shall be indicated with like reference numerals and similar features as shown in alternate embodiments in the Drawings shall be indicated with similar reference numerals.

Where used in this disclosure, the term ‘service context’ refers to a computer system's current and intended use. When the system is providing data or other content related services to users, it is in an ‘operational context’. When this system is being upgraded or is undergoing some level of administrative change, it is considered to be in an ‘administrative context’. The terms ‘shim’ and ‘filter’ or ‘filter driver’ shall be used interchangeably herein to describe enhanced or divergent portions of computer code that are introduced into the data flow of a software module. The terms ‘remote site’ and ‘remote system’ interchangeably refer to a logic element, computer, or portion thereof which is disposed outside of the kernel space of a host computer, as further defined herein.

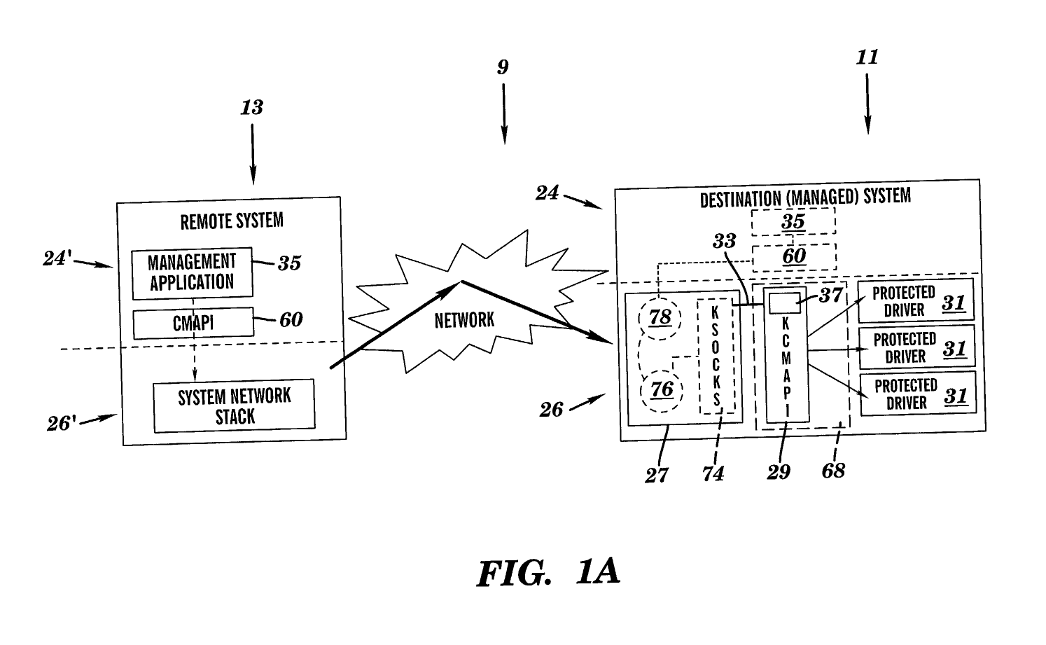

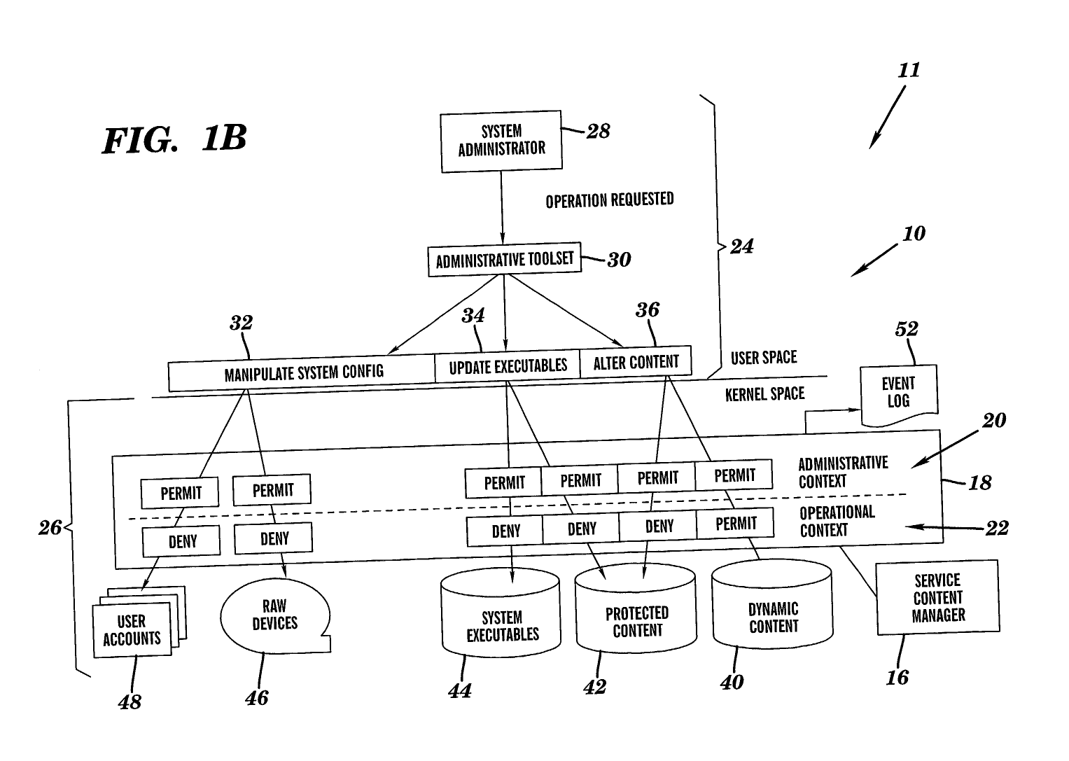

Referring to Figures, the principles of the present invention are shown. Turning now to FIG. 1A, the invention includes a communication system 9 that includes various components located within the kernel 26 of a protected (i.e., secured) computer system 11. This system 9 advantageously enables authenticated and/or encrypted communication between a remote application (e.g., management application 35 disposed on a remote system 13 or on a local system 11) and an underlying device driver(s) 31 on the host system 11.

Advantageously, as shown, instead of (or in addition to) using existing concepts of system trust, network filtering, and access control, to effect (administrative) access, the present invention enables protected communication to take place at a level below any administrative control and configuration, i.e., in the actual kernel space 26 of a protected system 11. As mentioned above, these components of system 9 located within kernel space 26 may be used for secure communication with various remote sites, including remote system 13 and/or user space 24 of system 11. Accordingly, for brevity, many aspects of communication system 9 of the present invention will be described herein with respect to communicating with one of system 13 and user space 24, with the understanding that such aspects are similarly applicable to the other.

As shown, in one embodiment, system 9 includes a transport module 27 communicably coupled to an authentication module 29, both modules 27 and 29 being located in the kernel space 26 of a protected computer system 11. As also shown, modules 27 and 29 are logically located within the communication path 33 between the remote site (e.g., system 13 and/or user space 24) and protected kernel-level components 31.

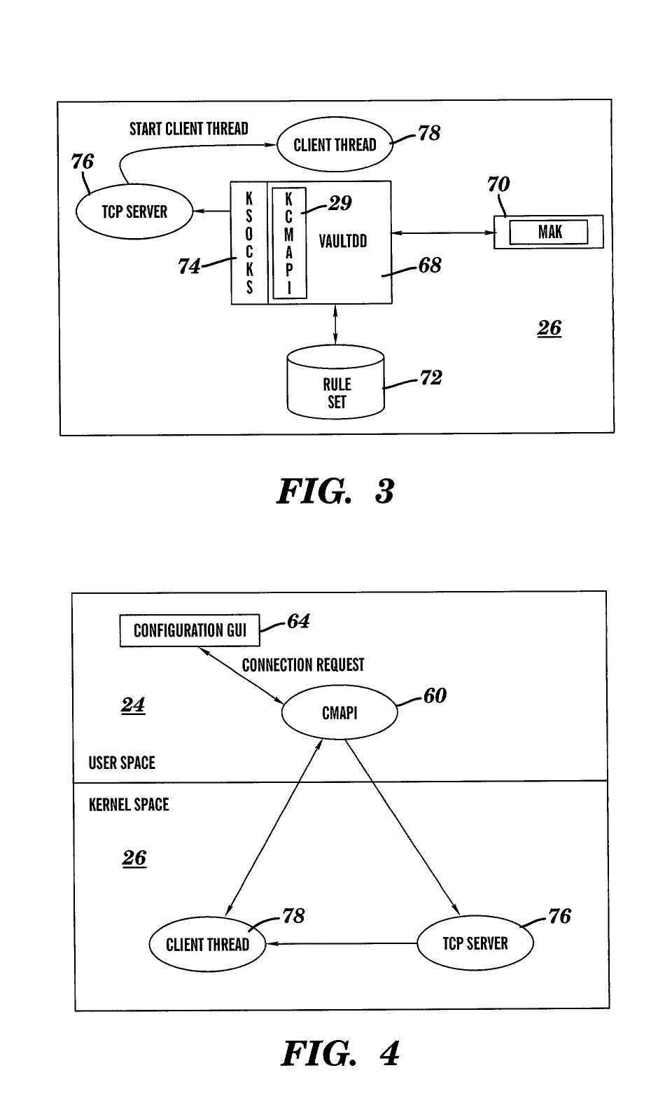

In a preferred embodiment, shown in phantom, transport module 27 includes a kernel-level communication API (also referred to as socket or KSOCKS) 74, which provides a kernel-based server (e.g., a TCP server) 76 and a conventional communication thread 78. Socket 74, server 76, and thread 78 are discussed in greater detail hereinbelow, e.g., with respect to FIG. 3. Described briefly, KSOCKS includes a set of routines that translate data and requests from packet-level network traffic into usable requests for authentication module (KCMAPI) 29. This use of KSOCKS 74 and module 29 advantageously enables communication to occur directly with the kernel space 26 without the need for any user-space 24 intermediary on the destination system. The KSOCKS implementation is shown and described for use with Microsoft™ NT™ systems, as it serves to provide access into existing (i.e., TDI) interfaces in the Microsoft kernel. The skilled artisan will recognize, however, that the present invention may be similarly adapted for use in other platforms, such as UNIX. In a UNIX environment, KSOCKS may be replaced with a conventional UNIX sockets implementation.

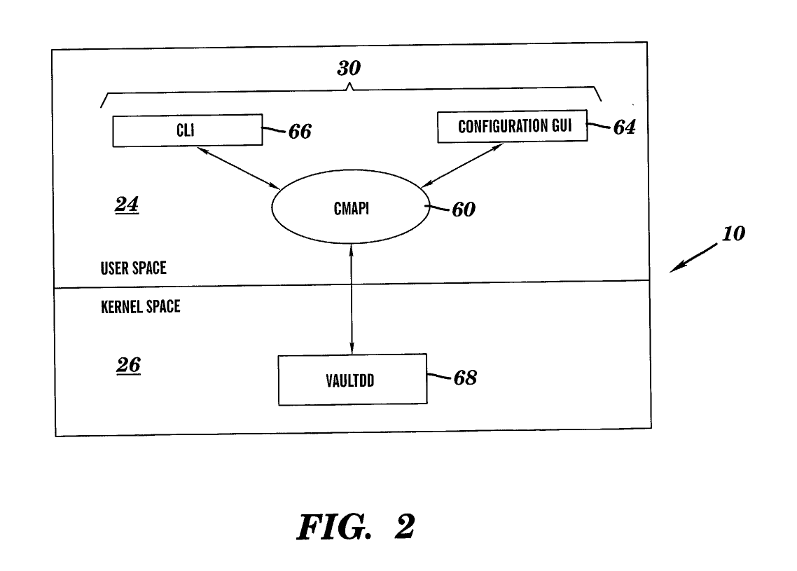

Module (i.e., KCMAPI) 29 preferably includes a kernel-level version of Configuration and Management API (CMAPI) 60 (CMAPI is discussed in greater detail hereinbelow with respect to FIG. 2). KCMAPI functions substantially similarly to CMAPI 60, though doing so at the kernel-end of communications path 33, i.e., within the kernel space 26. Briefly described, calls to KCMAPI implement driver routines and management functions to initiate, establish, and conduct communications within the kernel, i.e., at the kernel-end of the communication path 33. Similar, reverse operations are completed by CMAPI calls made in user-space 24 of system 11 and/or user space 24′ of remote system 13. In addition to these functions, KCMAPI 29 includes encryption module 37 which enables authentication of both the source and destination of these communications, and encryption. Encryption module 37 thus provides the authentication and encryption functions of KCMAPI in a manner similar to that described hereinbelow with respect to CMAPI 60. In a preferred embodiment, module 37 includes a PKI (Public Key Infrastructure, including a trust hierarchy, encryption, and/or digital signature services), such as a version of the “Certicom PKI™” (Certicom Corporation of Vancouver, Canada) which has been modified pursuant to the present invention for kernel-level operation. Module 37 thus provides hooks for making the actual communication private. This PKI is also enhanced to provide easy connectivity for the calling routines within the remote communications library of KSOCKS 74. Moreover, although the PKI encryption module has been discussed, in the alternative, encryption module 37 may include substantially any other encryption approach known to those skilled in the art, including DES (the U.S. Federal Government's Digital Encryption Standard), as discussed in greater detail hereinbelow.

As also shown in phantom, authentication module 29 is preferably incorporated within a filter driver (i.e., kernel-level shim(s)) 68. The filter driver/shim(s) 68 serves to suborn operating system control paths to recognize and/or permit some communications with driver 31, e.g., those originating from application 35, while it serves to block other communications. This configuration, including shim 68, provides a mechanism through which a prescribed set of actions, devices, and objects can be conveniently isolated from any administrator privilee-driven modification activity, i.e., to nominally prevent undesired communications with kernel-level component(s) 31. Shim 68 is described in greater detail hereinbelow.

Examples of kernel-level components 31 include dynamic content 40, protected content 42, system executables 44, devices 46, and user accounts 48, which are discussed in greater detail hereinbelow with respect to FIG. 1B.

In operation, transport module 27 receives communications from a remote site (i.e., management application 35) destined for driver 31, and transmits communications generated by driver 31. Authentication module 29 serves to authenticate and/or encrypt and decrypt communications between the kernel-level components 31 and the remote site. Thus, during operation of system 9, communications destined for the protected components 31 are received by the transport module 27, then routed to authentication module 29 for decryption and/or authentication, and ultimately routed to components 31. Communications originating from components 31 are handled in a similar, reverse manner, being encrypted by authentication module 29, then routed to transport module 27, which serves to transmit the communication to the remote site.

As described hereinabove, system 9 may be implemented to provide secure, direct, kernel-level communication with either a remote system 13 or with user space 24 of a host system 11. Moreover, although system 9 has been described as a stand-alone or independent system, it may be incorporated into other systems, such as a context management system 10 described hereinbelow, in which system 9 may be used to communicate with user space 24.

Turning now to FIG. 1B, such an alternate embodiment is shown, in which system 9 as incorporated into a host-based intrusion protection system 10 designed to prevent damage after a break-in has occurred. In order to create a robust and secure operating environment for a host system 11, i.e., a (internet) web server, instead of applying an increasingly complex hierarchical security model to maintain all of the current permutations of object access and user privilege, the present invention includes a mechanism for creating two distinct system service contexts. The first such context is an “administrative” context, in which conventional system protection and privileges apply. This means that well-known operating system protection, logging, etc. can be utilized for management of the system 11. Recognizing that for the majority of its useful life, however, the machine is in an operational context, and is not being modified, the present invention provides a second “operational” service context, where system resources, key content, user accounts, and other data are all protected from any changes. Similarly, by recognizing the differing level of monitoring and messaging associated with administrative and operational functions, the present invention creates a simpler information flow associated with activities in both contexts. Through this implementation, the present invention removes vulnerabilities created by the presence of the additional and unnecessary management functionality during normal operation, vulnerabilities which are at the heart of most system attacks and compromises.

In addition, the present invention provides several mechanisms to protect itself to help ensure that it is not circumvented or otherwise compromised. This self-protection is accomplished using several mechanisms/techniques. One such technique is to secure the device driver of the present invention, i.e., by requiring user authentication (including pre-authentication) and providing a secure channel for communications between user space and kernel space. Another technique is to effectively prevent bypass of the device driver of the present invention, and/or installation of other device drivers, by hooking system service calls. Registry keys, binaries, and files are also protected, i.e., using a filter driver (i.e., shim) and system service hooking. The present invention is further protected from conventional mechanisms for device driver management (e.g., “stop” and “unload”), and can nominally only be stopped by an authenticated request during the process of deinstallation.

The level of protection offered by the present invention is significantly superior to current technologies, both in security and in ease of operation. The host-level integrity assurance of the present invention fills the recognized gaps in existing technologies. Thus, while intrusion detection systems simply inform of ongoing and/or prior attacks, the present invention advantageously serves to protect the integrity of protected data in the event of such an attack, by substantially eliminating vulnerabilities inherent in standard operating system access controls.

In developing the intrusion protection product of the present invention, the aforementioned weaknesses were addressed and overcome. Using a new form of host-based security, data integrity and system viability can be protected against inappropriate system modifications, whether from hostile internal users or aggressive hackers. The invention nominally prohibits modification of key system resources and customer-specified data, denying efforts at alteration or deletion, even those executed with privileged system authority.

Referring to FIGS. 1B-8, the present invention will be more thoroughly described. Turning now to FIG. 1B, the present invention includes a mechanism for security that creates a functional differentiation of security and administrative control. As shown, this mechanism includes a Service Context Manager 16 which implements an enforced system service context as shown at 18, to differentiate between an Administrative Context 20 and an Operational Context 22. This enforcement includes operating system enhancements, logging and auditing changes, and secured preclusion mechanisms installed on conventional general purpose computer systems, as will be discussed in greater detail hereinbelow.

FIG. 1B includes some examples of these enforcement aspects. As shown, instructions passing from user space 24 into kernel space 26 are generally effected by a system administrator 28, using an administrative toolset (also referred to as a Configuration Client) 30. The toolset 30 typically enables at least three types of operations, i.e., Manipulation of System Configurations 32, Updating of Executables 34 and Alteration of Content 36. These instructions then pass from user space 24 into kernel space 26 where they are intercepted using kernel-level shim(s) (i.e., filter driver 68 (FIG. 2)), which is integrated with Service Context Manager 16, and will be discussed in greater detail hereinbelow. The Service Context Manager 16 thus intercepts the instructions passing into kernel space 26 and either permits or denies the requested operation. For example, as shown, instructions transmitted by Alter Content block 36 to alter dynamic content 40 are permitted in either administrative context 20 or operational context 22. Similar attempts by update executables 34 and/or alter content 36 to affect protected content 42 are permitted in administrative context 20, and denied in operational context 22. System Executables 44 may be altered in administrative context 20, while being denied in operational context 22. Similarly, instructions forwarded by Manipulate System Configuration 32 to affect raw devices 46 and/or user accounts 48 are respectively permitted and denied in Administrative and Operational Contexts 20 and 22. These and other examples of functionality provided within the administrative and operational contexts of the present invention as compared with the functionality of the prior art are shown in the following Table I.

TABLE I

| | Prior Art | | |
|---|---|---|---|
| | (No service | Administrative | Operational |
| Function | context) | Context | Context |
| Add/Modify/Delete | Permitted | Permitted | Denied |
| Users | | | |
| Modify/Delete | Permitted | Permitted | Denied |
| System Executables | | | |
| Access Raw Devices | Permitted | Permitted | Denied |
| Modify Read-only | Permitted | Permitted | Denied |
| Files | | | |
| Modify/Delete | Permitted | Permitted | Denied |
| Application Executables | | | |
| and Static Content | | | |
| Read Files | Permitted | Permitted | Permitted |
| Create Files | Permitted | Permitted | Permitted |
| Modify Dynamic Data | Permitted | Permitted | Permitted |
| Disable the present | N/A | Permitted | Permitted |
| invention Protection | | | |

As also shown, system 10 preferably includes an Event Log 52. To effect the above-described functionality, the system 10 includes several components. One component, mentioned briefly hereinabove, includes one or more kernel-level shims, i.e., filter driver 68, disposed integrally with service context manager 16. This shim(s) serves to suborn operating system control paths between user space 24 and kernel space 26. In the case of the present invention, the shims 68 reside in the operating system kernel, as shown in FIG. 2, between the user space 24 processes and the underlying device drivers (not shown), i.e., drivers associated with content 40, 42, executables 44, raw devices 46 and user accounts 48. In so doing, the present invention creates a mechanism through which a prescribed set of actions, devices, and objects can be isolated from any administrator privilege-driven modification activity when the system 10 is in its operational context.

This shim 68 (FIG. 2) may include one or more modified versions of commercially available shim products. For example, conventional shims are readily available to provide various types of enhanced operating system functionality, such as Storm Technologies' “Performance Shim™”, Computer Associates' “Access Control Shim™”, and the ClickNet host-based “Intrusion Detection Shim™”. These shims do not operate in a manner to create two separate service contexts, but do suborn the operating system to enhance performance, access control, and intrusion detection, respectively. However, these shim technologies may be modified and/or integrated to provide the functionality of the present invention.

For example, to effect the administrative context 20, service context manager 16 may disable the Storm™ and ClickNet™ shims, while enabling the CA™ shim. In administrative mode there is little need for performance enhancement or intrusion detection such as provided by the Storm and ClickNet shims. At the same time, there is a pressing need for improved access control granularity as provided by the CA shim. The converse is also true, as operational systems require better performance and better intrusion monitoring, and generally permit scarce system access that would require more granular access control. Thus, to effect operational context 22, service context manager 16 may enable the Storm™ and ClickNet™ shims, while disabling the CA™ shim as it is no longer needed. A preferred embodiment of shims useful in the present invention is discussed in greater detail hereinbelow with respect to filter driver (i.e., VaultDD) 68.

System 10 of the present invention also preferably includes a mechanism (discussed in greater detail hereinbelow) for providing encrypted kernel-level communication. In particular, this mechanism may include PKI-enabled kernel communication mechanisms. In this regard, in order to guarantee the consistency of the operational context, inter-process communications between kernel-level drivers should be both private and irrefutable. The kernel communication mechanism of the present invention provides such consistency and security. In one embodiment, the present invention may include “Certicom PKI™” (hereinafter, “PKI”) available from Certicom Corporation of Vancouver, Canada, as modified for kernel operation using KSOCKS as discussed hereinbelow. However, other products, such as that provided by RSA, Inc. could be integrated through the expense of only moderate effort to recompile the RSA product.

In addition, for reasons similar to those discussed above with respect to the kernel-space communication issues, communications relating to administration, i.e., between the Administrative Toolset 30 or management console, and kernel space 26, are preferably secured. The mechanism for this is CMAPI 60, which is preferably a PKI-enabled implementation of kernel-space to user-space authentication and channel encryption. CMAPI 60 will be discussed in greater detail hereinbelow.

Turning now to FIG. 2, system 10 of the present invention resides within a basic structure of three main components: configuration clients (i.e., administrative toolset) 30, a Configuration Manager API (CMAPI) 60, and a device driver (i.e., filter driver or VaultDD) 68. As shown, configuration client 30 may include a suite of tools including a Configuration GUI 64 and a command line interface (CLIDE) 66. These are used for such operations as adding rules (discussed hereinbelow) and turning protection on and off. Administrative toolset 30 is thus used to enable, disable, and configure constructs (i.e., shim modules), associated with both service contexts 20 and 22. Moreover, toolset 30 is preferably integratable into well-known enterprise management frameworks such as HP OpenView and CA Unicenter. From these platforms, the setting of service context may be conveniently undertaken, i.e., from a menu operation on a selected representative icon or group of icons.

CMAPI 60 is an object-based library, which provides a secure mechanism for communications between configuration clients and the device driver 68, as will be discussed in greater detail hereinbelow. Device driver (i.e., VaultDD) 68 is integrated with Service Context Manager 16 (FIG. 1B) and thus provides the aforementioned dual context protection to the host computer system (not shown). As also shown, configuration client 30 and CMAPI 60 both exist in user space 24, while VaultDD 68 exists in kernel space 26.

As mentioned hereinabove, individual components of system 10 of the present invention use standard protocols and well-known techniques. This will become evident throughout the following discussion. For example, as discussed, the authentication techniques used for communication between CMAPI 60 and VaultDD 68 include a PKI (e.g., Certicom PKI™) and DES. Filter drivers (shims) and system service hooking (described hereinbelow) are also well known to those skilled in the art of NT™ programming.

A significant aspect of system 10 of the present invention is providing security to the system 10 itself System 10 provides this protection by using secure and authenticated communications between the configuration tools 30 and device driver 68, to nominally prevent system 10 from being replaced and and/or circumvented. This self-protection is now discussed in detail.

Configuration

Any configuration command, such as adding a new rule (discussed hereinbelow) or turning on machine protection, will be issued from CMAPI 60. Neither the Configuration GUI 64 nor CLIDE 66 will communicate directly with VaultDD 68. Before any configuration operations occur, the user wishing to apply the changes must be authenticated. The basis for authentication is the Management Authentication Key (MAK) 70 (FIG. 3), which is created from a password. Once authenticated, the user is capable of making any changes. Optionally, the password required to create MAK 70 may be supplemented by a SecurID, as will be discussed hereinbelow.

In order to configure VaultDD 68, a user must know the management password. Not only must VaultDD 68 configuration be protected through use of a password, but also the password itself must be protected. The initial password cannot be created without the product installation media. An application run during installation prompts the user for password entry. Password strength will be strictly enforced at password creation and modification time.

During password creation, a user enters the desired password. If the password passes the strength test, (i.e., the password is sufficiently random) it is then hashed using a suitable hashing algorithm, such as the algorithm commonly known as “MD5” developed by Professor Ronald L. Rivest of MIT. A commercially available version of the MD5 is identified as the “RSA Data Security, Inc., MD5 Message-Digest Algorithm” available from RSA Data Security, Inc. The skilled artisan will recognize that such a hashing algorithm is preferably used because it is relatively difficult to reverse, i.e., in the event one were to intercept the hashed value, it would be relatively difficult to derive the original (clear text) password therefrom. The hashed password serves as the Management Authentication Key (MAK) 70. The MAK is thus created to further enforce protection of the password. The password itself (i.e., the clear text version) is not stored within system 10. Only MAK 70 is stored. MAK 70 is stored in a hidden registry key(s) within VaultDD 68 to substantially prevent any type of read-only or read/write access. The MAK once created, is securely transferred to VaultDD using CMAPI.

Subsequent changes to the password will require knowledge of the old password.

As mentioned hereinabove, CMAPI 60 is provided to communicate with VaultDD (device driver) 68 from user space. In the embodiment shown, CMAPI 60 is a static library, which provides an object, which in the example described herein, is called NTegCMSecurityPlatform. As used herein, the term CMAPI 60 is used to interchangeably refer to both CMAPI and the NTegCMSecurityPlatform object.

As mentioned hereinabove, a core component of CMAPI is its set of security tools. The major portion of these tools is provided through Certicom™ libraries available from Certicom Corporation. These libraries provide functionality for DES, PKI, and other security features such as SecurID. CMAPI implements these mechanisms, hiding the details from configuration client(s) 30. CMAPI's additional functionality, such as functions 32, 34 and 36 discussed hereinabove, are exposed to, i.e., selectable by, a user or system administrator 28. In a preferred example, additional exposed functionality provided by CMAPI include:

Connect: establishes the initial connection between CMAPI and the device driver

PreAuthenticate: encrypts the user-supplied password with VaultDD's public key

Authenticate: authenticates the user to VaultDD

SetMachineProtection: sets the protection of the machine, i.e. on or off

SetMachineRules: creates new rules

QueryMachineRules: queries existing rule set

Disconnect: closes connection to VaultDD

Preferably, CMAPI 60 changes state as different methods are called. For instance, CMAPI 60 rejects all commands until it sees a Connect request. After a successful Connect, CMAPI 60 will only accept a PreAuthenticate request. It will then reject all other commands until a successful Authenticate is performed. Once a user is authenticated, then commands such as SetMachineProtection can be issued.

The PreAuthenticate and Authenticate functions are separated to provide for enhanced password protection. As discussed above, at some point a password must be entered by the user. This means that the clear text password must exist in memory for some discrete period of time. This is clearly unavoidable. However, the time that the clear text password exists should preferably be minimized. Since the authentication process, especially in the case of remote configuration, may be lengthy and potentially lead to a time-out situation, it is undesirable to store the password in memory while this operation is completed. Thus, in a preferred embodiment, a first operation configuration tool 64 or 66 performs with the password is to call PreAuthenticate, which encrypts the password with the public key of the device driver 68. The clear text password is then zeroed out. This advantageously minimizes the time that the clear text password remains in memory.

Turning now to FIG. 3, the components of system 10 residing in kernel space 26 are described in greater detail. VaultDD 68 and MAK 70 were described hereinabove. In addition thereto, Rule Set 72 is communicably coupled to VaultDD 68 and also resides in kernel space 26. Rule Set 72 determines which files, registry settings, and the like, are protected by system 10. In particular, Rule Set 72 is used by Service Context Manager 16 (FIG. 1B) as described hereinabove to implement the enforced system service context shown at 18 (FIG. 1B), i.e., to differentiate between Administrative and Operational Contexts 20 and 22, respectively (FIG. 1B). Remaining kernel space components include a kernel socket, i.e., kernel socket library 74 integrally coupled to VaultDD 68 as shown. Kernel socket 74, in turn, is communicably coupled to a server 76, which in turn starts a client thread 78. Server 76 is preferably a conventional TCP (or TCP/IP) Server program. As shown, socket 74, server 76 and client thread 78 are all disposed within kernel space 26 and provide a communications path to device driver 68.

With respect to kernel socket 74, the skilled artisan will recognize that Microsoft® Windows NT™ creates user and kernel space in an attempt to protect kernel memory space and processes. This means that communicating between these two spaces is not trivial. One approach to provide such communication, especially given the possibility of remote configuration, is to use a well-known protocol such as TCP/IP. However, the Windows™ implementation of sockets (Winsock™) for TCP/IP communication is available only in user space. Opening sockets for communication in the kernel is thus not inherently supported in Windows NT™. To overcome this difficulty, system 10 of the present invention incorporates the aforementioned kernel socket 74, which in a preferred embodiment, includes a kernel sockets library sold under the designation KSOCKS™ by Open System Resources (OSR). KSOCKS™ is based on BSD (Berkeley Software Distribution UNIX) sockets. KSOCKS™ has been extensively tested and found to provide a robust solution for socket implementation in the kernel. With the inclusion of KSOCKS 74, VaultDD 68 has a standard communication protocol with which to talk to user space.

Turning now to FIG. 4, operation of establishing a communication connection or path between CMAPI 60 and kernel space portions of system 10 is discussed. When VaultDD 68 (FIG. 3) is loaded, it starts the TCP/IP server 76, which in turn, manages communications with CMAPI 60. When the TCP server 76 is started, it performs three operations: bind, listen, and accept. The bind operation binds the server to a specified port (i.e., a software port) of the host computer system. Listen sets up the server for connection requests, performing operations such as setting up the listening queue to receive incoming communications. Accept is a blocking operation such that when an incoming request is received, Accept does not return control until it is finished receiving the request. Accept returns a socket for use in communications with CMAPI 60. The TCP server 76 then launches a separate thread, Client Thread 78, to handle communications on the newly assigned socket.

Thereafter, as shown in FIG. 4, a user may issue a connection request 1 to CMAPI 60, for example, using Configuration GUI 64 as shown. An initial connection 2 between CMAPI 60 and Server 76 is then established. After Accept has been returned by Server 76, Server 76 starts Client Thread 78. Client Thread 78, in turn, communicates 4 bi-directionally with CMAPI 60. Thus, while from the perspective of CMAPI 60, it is communicating with the TCP server 76, CMAPI 60 is actually communicating with a separate thread 78 launched from server 76.

At this point, the connection has been established, but it is not yet secure. There are at least two steps to this security. A first is authenticating the user, i.e., verifying that the person wishing to perform some configuration is authorized to do so. A second step includes hardening the connection. These steps are part of the authentication protocol.

Authentication Protocol

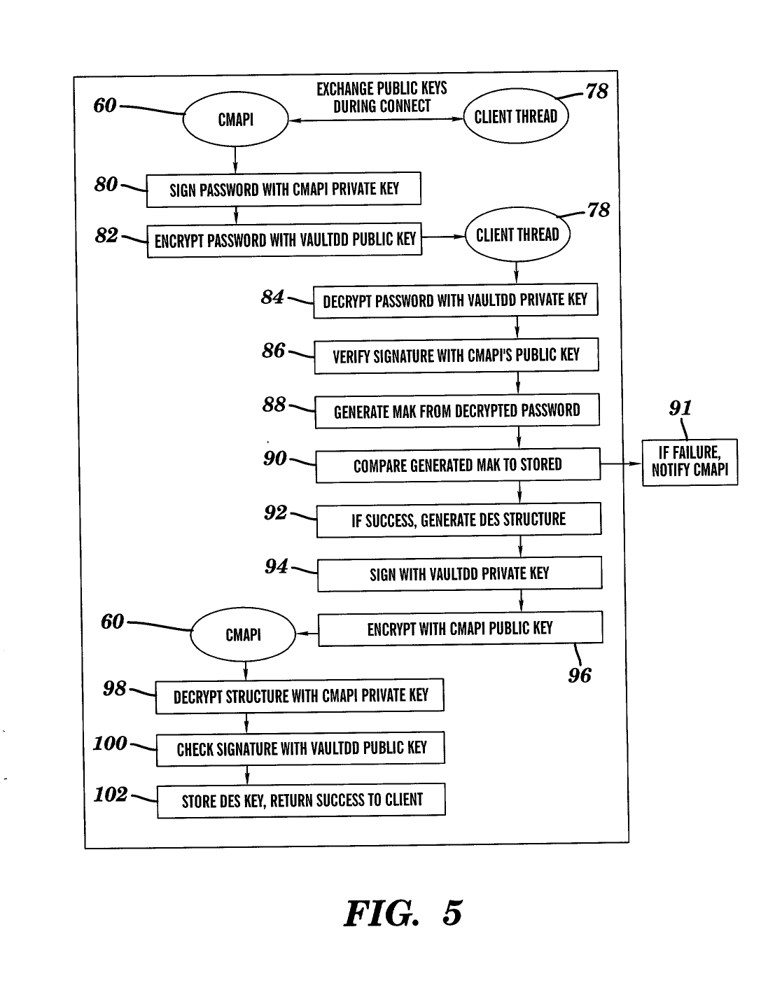

Referring now to FIG. 5, the aforementioned authentication protocol will be discussed in greater detail. As mentioned hereinabove, an important aspect of enabling system 10 to protect itself, is ensuring that only authenticated users can perform configuration. This means that there is not only the issue of authenticating a user, but also of protecting the entire authentication process. Also, the protection is not limited to authentication; but all commands sent to VaultDD 68 preferably must be secure. The protocol for secure communications between CMAPI 60 and VaultDD 68 specifically takes place between CMAPI 60 and Client Thread 78, as shown in FIG. 3.

Securing the Connection

As discussed hereinabove, the security of the connection is predicated on PKI and DES. PKI encryption is used until the initial authentication is complete. After authentication, the encryption model preferably changes from PKI to DES. The reason for using DES™ is that it is faster and thus tends to reduce processing time, particularly with rule intensive queries. For example, if there is a query for 4,000 rules, the encryption of these rules is significantly faster using DES than PKI. The skilled artisan should recognize, however, that any encryption model, regardless of processing speed, may be used in conjunction with the present invention without departing from the spirit and scope of the present invention.

During the Connect operation 1 (FIG. 4), CMAPI 60 and VaultDD (i.e., Client Thread) exchange public keys. Next, the configuration client (i.e., Configuration GUI 64) will call PreAuthenticate. PreAuthenticate occurs independently of VaultDD. Rather, as discussed above, PreAuthenticate simply serves to encrypt the password using the public key of the VaultDD 68. Thereafter, the CMAPI-VaultDD (i.e., CMAPI-Client Thread) channel is authenticated and hardened. This is accomplished by signing 80 the encrypted password held by CMAPI (from PreAuthenticate), with CMAPI's private key and encrypting 82 with VaultDD's public key. The CMAPI Authenticate operation bundles up the password using a suitable communication protocol (i.e., TCP in the embodiment shown and described herein) and sends it to client thread 78.

Upon receiving the password bundle, the Client Thread first decrypts 84 the password using VaultDD's private key. It then verifies 86 the signature using CMAPI's public key. Next, the Client Thread generates 88 a new MAK by hashing the decrypted password. The thread then compares 90 the newly generated MAK to the stored MAK 70 (FIG. 3). If this MAK verification fails, then the client notifies CMAPI 60, as shown at 90, which in turn will send an appropriate return code to the configuration client 64. It is up to the client 64 how to handle that failure (i.e. re-prompt for password, etc.). There are at least three failure scenarios:

Some operation on the local machine (where the client resides) failed, e.g., failure of a malloc operation, Certicom initialization failure, etc.;

Authentication failed, usually meaning a bad password; and

Authentication timed out.

If the MAK comparison is successful, a DES™ structure is generated 92. This structure includes a DES key (i.e., a shared secret session key used to encrypt session communications post authentication, such as to effect protection and rules changes) and conventional information about how DES will work, such as type of DES, etc. The DES structure is signed 94 with VaultDD's private key. It is then encrypted 96 with CMAPI's public key. This packet is then bundled up and sent back to CMAPI 60. CMAPI then which decrypts 98 the structure with CMAPI's private key, checks 100 the signature with VaultDD's public key and stores 102 the DES key. All subsequent commands, i.e. SetMachineProtection, will be encrypted with DES. The DES key only operates for that particular session. If the session is disconnected, Authenticate must be called, restarting the process.

Security Bundle Packet

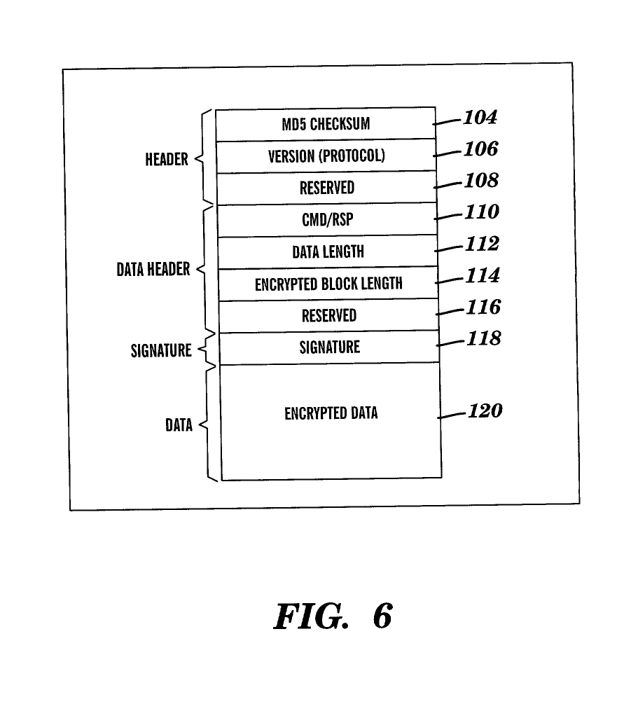

The foregoing discussion mentions a bundle being passed between CMAPI and the client thread. Turning now to FIG. 6, this bundle will be described in greater detail. As shown, the fields are defined as follows:

MD5 Checksum 104 is a hash of the data header. This MD5 is a commercially available hashing algorithm, such as the “RSA Data Security, Inc., MD5 Message-Digest Algorithm” discussed hereinabove. It is used in a conventional manner to provide additional randomness to help prevent spoofing of a command and signature.

Version 106 is the version of this protocol being used.

Reserved 108 is a field that is reserved for future use.

CMD/RSP 110 is a conventional union field, i.e., a structure that can be used to represent the same data in different ways (such as (4) 8 bit char vs. (1) 32 bit int). When CMAPI uses it, it includes a command, such as Connect. When VaultDD 68 uses it, it returns the success or failure of that command.

Data Length 112 is the length of the unencrypted data, since data length is variable.

Encrypted Block Length 114 is the block length that was used during encryption. This is necessary since a fixed block size is used in encryption, meaning that padding is sometimes necessary. Decryption requires knowledge of the data length encrypted.

Reserved 116 is a field that is reserved for future use.

Signature 118 is the signature generated using the sending entity's private key. When CMAPI sends an Authenticate command, it will sign with its private key, as discussed hereinabove, to help ensure that the packet came from CMAPI.

Encrypted data 120 is the payload, i.e., the DES structure used during authentication, or a rule set. The data is encrypted using the receiving entity's public key during Authenticate or with DES key for subsequent commands. For instance, when VaultDD generates the DES structure during authentication, it encrypts it using CMAPI's Public Key.

It is important to note that after a successful authentication as shown and described hereinabove with respect to FIG. 5, subsequent commands such as setting machine protection, adding rules, etc., will use DES encryption, while PKI will be used only for signatures. However, the steps performed (FIG. 5) and the packets built (FIG. 6) are substantially identical as those for Authentication. The skilled artisan will recognize that all of these commands follow the same protocol, so understanding how one is issued (i.e., with respect to Authentication) clarifies how all are used.

Rule Set Management

With authentication complete, configuration is possible. One important aspect of this configuration is adding, deleting, and querying rule set 72 (FIG. 3). As mentioned hereinabove, such rules, for example, include instructions used by service context manager 16 (FIG. 1B) to determine which communications and/or operations will be permitted/denied in administrative and operational contexts 18 and 20 (FIG. 1B), respectively. The VaultDD kernel device driver 68 (FIG. 2) needs a mechanism to store, retrieve, and update an in memory representation of the configured rule set. In particular, a kernel rules interface (not shown) is needed to support the rules, the format of the rules, how the on disk rules are secured against tampering, and how rules are initialized from their on disk representation. This kernel rules interface (API) preferably supports at least the following functionality:

A fetch operation that returns all rules currently loaded into memory by VaultDD

A query operation that checks for a single rule.

An add operation that adds both single and lists of rules

A delete operation that deletes either a single rule or a list of rules

A store operation that stores the rules on a permanent storage device

A cache operation which stores recently added rules to a temporary cache file until a store operation is completed

An initialize operation that builds the initial in memory rules representation from the rules file stored on the permanent storage device, including the cache file if it exists

VaultDD Rules Table Structure

The kernel rules are implemented using a global hash table. The hashing algorithm uses a universal hash function with pseudo random numbers to achieve adequate key dispersion. The average probability of a collision between two distinct keys for a table of size M is approximately 1/M.

An exemplary hash table implementation defines the following structures:

```
//STATUS codes enumeration
typedef enum {
    STATUS_OK,
    STATUS_MEM_EXHAUSTED,
    STATUS_RULE_NOT_FOUND,
    STATUS_RULE_FOUND,
    STATUS_GENERIC_ERROR
} RLS_STATUS;
//KEY definition
typedefUNICODE_STRING KEY;
//RECORD definition
typedef struct_RECORD {
    long flags;
} RECORD, *PRECORD;
//RULES definition
typedef struct_VLT_RULE {
    KEY key[_MAX_PATH+1];
    RECORD rec;
} VLT_RULE, *PVLT_RULE;
typedef struct_HASHNODE {
    struct_HASHNODE *next;
    RULE rule;
} HASHNODE, *PHASHNODE;
typedef struct_HASHTABLE {
    PHASHNODE *pRulesTable;
    ERESOURCE hashTableRes;
    long hashTableSize;
    long numHashTableRules;
    long numHashCollisions;
    TABLE_TYPE tType;
} HASHTABLE, *PHASHTABLE;
```

As should be clear by the HASHNODE definition, the hashing algorithm uses separate chaining to handle collisions. The method of separate chaining creates a linked list of rules whenever a rules collision occurs. For example, in the event a rule A and rule C hash to the same value, a collision is caused in the rules table. A link list of rules is then created at the collision point with each rule in the collision chained off the list's “next pointer”. The rules engine must detect the collision and follow the linked list searching for a direct match of each text (pre-hashed) rule in the list. If the text rule matches, then there is a rule match.

VaultDD Rules API

The following are exemplary functions provided within the rules API of VaultDD 68 to affect the aforementioned rules operations:

RLS_STATUS Vlt_QueryRule (IN PHASHTABLE pHashTable, IN VLT_RULE rule);

RLS_STATUS Vlt_DelRule (OUT PHASHTABLE pHashTable, IN VLT_RULE rule);

RLS_STATUS Vlt_DelRules (OUT PHASHTABLE pHashTable, IN PVOID pInBuf);

RLS_STATUS Vlt₁₃ AddRule (OUT PHASHTABLE pHashTable, IN VLT_RULE rule;

RLS_STATUS Vlt_AddRules (OUT PHASHTABLE pHashTable, IN PVOID pInBuf);

RLS_STATUS Vlt_FetchRules (OUT PHASHTABLE pHashTable);

RLS_STATUS Vlt_DumpRulesToDisk (IN PHASHTABLE pHashTable, IN PUNICODE_STRING outputFile);

RLS_STATUS Vlt_InitializeRules (OUT PHASHTABLE pHashTable, long size);

VaultDD Rules Permanent Storage and File Caching

The VaultDD device driver 68 (FIG. 2) is responsible for maintaining an on disk representation of the in memory rules structure. In order to maximize performance for a large rule set, two files are used:

1. A cache file is used to store any rule changes that have occurred before the complete rule set has been saved to disk. This file is preferably removed whenever a successful call to Vlt_DumpRulesToDisk has been completed. The hidden registry key HKLM\SYSTEM\Services\VaultDD\cachefile points to the name and location of the cache file and must be created during the initial installation of the product. The hidden registry key HKLM\SYSTEM\Services\VaultDD\cachefile points to the MD5 checksum of the cache file. This key is updated by dumping the rules cache table (pointed to by the pRulesCache member of the HASHTABLE structure) whenever a rule change request is received by the GUI 64 (FIG. 2).

2. A conventional binary file is used to contain the complete rules since the last successful call to Vlt_DumpRulesToDisk. This file is updated whenever the driver is unloaded or a call to VIt_DumpRulesToDisk is completed. The hidden registry key HKLM\SYSTEM\Services\VaultDD\rules points to the name and location of the rules file and must be created during initial installation of the product. The hidden registry key HKLM\SYSTEM\Services\VaultDD\rulescksm points to the MD5 checksum of the rules file. This registry key is updated whenever the rules are dumped to disk.

VaultDD Permanent Storage Integrity

The integrity of the permanent storage files, both the default rules file and the rules cache file, is ensured by storing a MD5 checksum of the file in the registry as a hidden key and protected by the device driver 68 (FIG. 2). This protection substantially ensures that the MD5 can only be updated by the driver 68. During the initialization of the rules the MD5 of the file is computed. If the MD5 file does not match that which is stored in memory, then the device driver loads only the default rules and a notification is sent to the NT Event Log 52 (FIG. 1B) that a MD5 mismatch of the rules has occurred. At this point, it is up to the administrator to reconfigure the device driver 68 from the rules file(s) created at installation time.

System Protection Mechanisms

In addition to the enforced security contexts and the secure communication protocols used to communicate between user space 24 and kernel space 26, several other protection mechanisms and/or techniques may be preferably used by system 10. These additional protection mechanisms are used to protect both the host system and also system 10 itself System 10 provides protection of files (user files, binaries, system files, etc.) and also of registry keys. File system protection is accomplished using a filter driver or shim, while registry protection is afforded by hooking system service calls. The following will first provide generic NT™ background on each of these methods and then provide greater detail relating to how system 10 uses the methods.

NT Device Drivers

The development of the kernel component of the present invention, i.e. the device driver 68, faced many challenges. As discussed hereinabove, one of the primary tasks of the driver 68 is to perform the shim (filter) functions, i.e., to intercept all requests to write files to disk. In order to perform this operation successfully, the driver has to be loaded and perform certain operations in an exact sequence every time. In order to understand how and why this is the case, it is necessary to understand the Windows NT architecture of drivers, devices, and IRP's (I/O Request Packets). The following provides an introduction to these concepts and explains their significance to the system 10.

The skilled artisan will recognize that at a basic level, a device driver is a piece of software that is loaded into the kernel space to handle I/O operations between the OS and its associated hardware (i.e. the devices). In NT™, there are essentially three types of drivers:

Hardware device drivers that handle I/O via HAL to hardware such as hard drives and NICs (Network Interface Cards).

File system drivers that handle I/O request at a file level and forward them to a device. This group also includes network redirectors.

Filter drivers that intercept I/O and requests and perform additional processing, such as VaultDD device driver 68 (FIG. 1B).

Internally, NT represents these drivers as ‘driver objects’. The NT I/O manager can then keep track of the various drivers for forwarding requests. NT also uses ‘device objects,’ which represent the physical (driven) device itself ‘Device objects’ are created by ‘driver objects.’ This is logical as the driver manages a device, so the driver object manages the device object. For instance, at boot time, the driver for a hard disk is loaded into the kernel. A driver object is then created to represent this driver. Then, the driver object will create a device object that represents the disk itself The result is a driver object representing the driver and a device object representing the device.

The I/O Request Packet (IRP) is simply a data structure representing a request for some sort of I/O. Thus, conceptually, the device object represents the device that is being written to. The driver object handles how that write will take place. The IRP then is the request that the write take place. For example, from an application such as Microsoft® Word™, a user hits the Save icon. This initiates a function call that finds its way down to the I/O Manager in kernel space. The I/O Manager has to decide where to send this save request, i.e. which device should receive this save. The I/O Manager will construct an IRP containing the save request and send it on its way to the target device object.

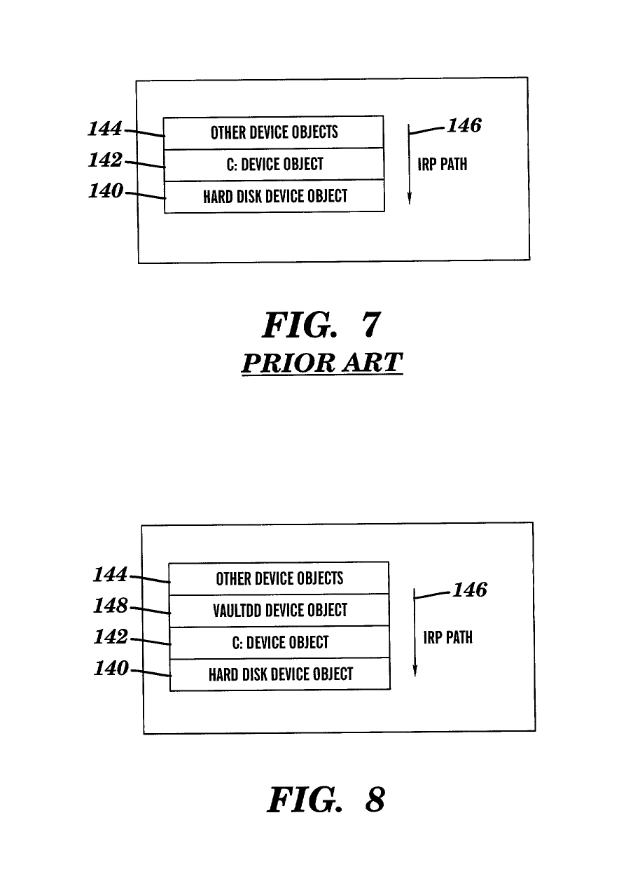

To understand how an IRP finds its way to the correct device, it is first necessary to comprehend the concept of attaching one device to another. A representative example of this concept is shown in FIG. 7. Referring to FIG. 7, consider a hard disk as the destination of I/O. As shown, there is a disk device object 140 representing the disk. Up one level, there is also a logical volume device object 142 created by the Windows™ file system driver (not shown) that represents a logical volume on this disk. For instance, if a disk has C:\ and D:\ volumes, there needs to be some sort of representation of these entities. In Windows NT™, this is accomplished by representing each of the logical volumes as discrete device objects. Since the file system is a driver and is responsible for managing these logical volumes, the file system driver object (not shown) creates and manages the logical volume device objects.

At this point, there are device objects representing the physical disk and the logical volumes. The concept of attaching devices is used to ensure that a request (i.e., to write C:) gets where it needs to go. In this regard, when a logical volume device object (i.e., 142) is created, it is attached to the disk device object (i.e., 140). The attached objects then form a sort of stack. (The stack is actually a linked list, but the stack concept is useful.) The last device to attach itself to another is inserted at the head of the linked list, such as shown as Other Device Objects 144. Thinking of the list as a stack, this means that the last device attached is at the top of the stack.

When the I/O Manager (located within kernel space 26) receives a request to write to disk, it determines a target device object to send the request to (this request is the IRP). It identifies the disk device object as the target and looks at its attached device list. It then sends the IRP to the first device object in that list (the top of the stack). This means that the last device to attach is actually the first to get the IRP. The IRP is then passed though the stack to the target device. However, it is important to note that each device object has the option of processing the IRP or passing it on. This is critical to how a filter driver operates.

In the example shown in FIG. 7, any requests to write to the hard disk will propagate down this stack, in the direction 146 with each layer having the option to process or pass on the IRP before reaching the hard disk. Some IRP's may never reach the hard disk depending on actions taken by the above device objects.

Device Driver (VaultDD) 68

As discussed hereinabove, VaultDD 68 (FIG. 2) includes a file system filter driver for protecting the file system and in addition, performs system call hooking to protect the registry. One of its primary tasks is to protect writes to given files. This task is accomplished by inserting a VaultDD Device Object 146 in the IRP stack of a logical volume as shown in FIG. 8, where it intercepts write requests to disk. By intercepting these requests, VaultDD 68 (FIG. 2) can take a write request, check if the file is protected, (i.e., the system 10 is disposed in Operational Context 22 and the particular rule is set to “Deny” in Service Context Manager 16) and deny the write if it is. If the file is not protected, (i.e., the operation is set to “Permit” in Service Context Manager 16) the IRP is passed along and the write is successful.

It is helpful at this point to clarify some of the operations that typically occur with respect to the Windows™ file system driver as the system boots. When the file system driver is loaded, it generally creates several device objects. For example, it creates a file system device object representing the file system itself It also creates, as previously discussed, device objects (i.e., 142) representing logical volumes. Additional processing is also generally required to set up conventional data structures. For example, some of these data structures are preprocessing for the mount operation, during which the file system device mounts the Logical Volume, i.e., the Volume Device Object 142. The actual mount operation is triggered by an IRP sent from the Windows™ I/O Manager (not shown).

The present invention must be informed of which logical volumes exist on the host system. This may be accomplished by requiring users to specify logical volumes during initial installation of the system 10. It may also be feasible to have system 10 make such a determination automatically at various intervals, to help ensure that system 10 is aware of any logical volumes created after its initial installation.

Hooking System Service Calls

Once installed as set forth hereinabove, system 10 provides the aforementioned protection to the device driver 68 using system service hooking. One skilled in the art will recognize that the conventional Windows NT™ kernel provides a number of system services (functions) that are core to any operating system. User space applications do not call these functions directly. Rather, they call corresponding functions in NT™ provided user space DLL's. For instance, an application that wishes to open a file will generate a call to CreateFile in KERNEL32.DLL, a user space DLL. This in turn will make a call to NTDLL.DLL, also in user space. It is here that a system service call is actually made. In this case, the corresponding system service to CreateFile is NtCreateFile. NtCreateFile in turn triggers a series of steps by the I/O manager.

For NTDLL.DLL to call the system service, a context switch from user space to kernel space is necessitated. This is accomplished by generating an INT 2E instruction, which generates an interrupt. In order to call the appropriate kernel function, the kernel exports a system service table called KeSystemServiceTable. This is basically an array, indexed by ID, of function pointers. Each system service has a corresponding pointer in the table. The NTDLL.DLL specifies the specific ID of the service it needs to call, hence the interrupt handler calls the appropriate function.

The idea behind system service hooking performed by the present invention is to intercept calls to the system services. This is performed by replacing the pointer in the KeSystemServiceTable corresponding to the system service with a different pointer. For example, RegCreateKey is a conventional system service used to create Windows™ registry keys. In the event one wanted to prevent the creation of any registry keys, one may write a separate function with the same prototype (i.e., with the same call signature including name and parameter definitions) as the WindowsNT™ RegCreateKey. Next, the pointer in the system table to the original RegCreateKey is replaced with a pointer to the newly written function. Now, when RegCreateKey is called, it actually calls the newly written function, which, in this example, denies key creation. This is system service call hooking.

Registry Protection

With an understanding of system call hooking, it is now possible to understand aspects of the protection of the NT™ registry provided by system 10. There are ten conventional system services for dealing with the registry. They are:

RegOpenKey

RegQueryKey

RegQueryValueKey

RegEnumerateValueKey

RegSetValueKey

RegCreateKey

RegDeleteValueKey

RegDeleteKey

RegFlushKey

When VaultDD 68 is loaded, it modifies the system service table by replacing all ten of the above function pointers to point to functions of VaultDD. Therefore, any attempt to modify the registry will first call a function of system 10. Each function will check for a violation of the rules of system 10 (i.e., an attempt to implement a function that is to be ‘Denied’ by Service Context Manager 16 (FIG. 1B), such as trying to write to a protected location. If there is no violation, then the original NT™ system services are called, all transparent to the user. However, in the event there is a rule violation, the original registry function is never called and the operation is denied.

This approach thus advantageously secures the configuration of VaultDD 68. In addition, such service call hooking is also preferably used to prevent installation of other drivers, i.e., malicious drivers intended to circumvent or disable system 10. This is accomplished by hooking a call to RegCreateKey when the path specified by the user is the location of keys used by device drivers, (i.e., HKEY_LOCAL_MACHINE\CurrentControlSet\Services in NT™).

The service hooking operation of the present invention continues to operate effectively even in the event other device drivers modify the system service table to provide similar service hooking. There are two such possibilities, a device driver that modifies the system service table before VaultDD or one that hooks after VaultDD. In the ‘before’ case, VaultDD is replacing someone else's function, not the NT™ system service. In this instance, in the event there is no rule violation, VaultDD will be calling someone else's function, instead of the system service. However, protection is still enforced since VaultDD has processed the call. In the ‘after’ case, someone else's function has replaced VaultDD's function in the system service table. However, after this other function performs its processing, it will still call VaultDD. Thus, in this instance, protection is still enforced by VaultDD.

Thus, as discussed hereinabove, the present invention provides increased protection for a host computer system by providing alternative Administrative and Operational Contexts 20 and 22, which selectively permit and deny specific enumerated operations. In addition, the present invention provides several mechanisms to protect itself to help ensure that system 10 is not circumvented or otherwise compromised. As also discussed hereinabove, this self-protection is accomplished in four general ways:

Securing configuration of VaultDD, i.e., by requiring user (pre)authentication and providing a secure channel for communications between user space and kernel space;

Preventing bypass of VaultDD and/or installation of other device drivers, i.e., by hooking system service calls;

Protecting registry keys, binaries, and files, i.e., using a filter driver and system service hooking; and

Providing no unload functionality (to protect system 10 from being unloaded, except during a re-boot).

While embodiments set forth hereinabove have been described as implemented on a Windows NT® platform, the skilled artisan will recognize that the teachings hereof may be used in combination with any operating system having both user space and kernel space, such as UNIX®, LINUX™, SOLARIS™, etc., without departing from the spirit and scope of the present invention.

The foregoing description is intended primarily for purposes of illustration. Although the invention has been shown and described with respect to an exemplary embodiment thereof, it should be understood by those skilled in the art that the foregoing and various other changes, omissions, and additions in the form and detail thereof may be made therein without departing from the spirit and scope of the invention.

Having thus described the invention, what is claimed is:

1. A method of providing secure communication with kernel-level components of a computer system having an operating system that includes user space and kernel space, said method comprising the steps of:
(a) disposing an authentication module in the kernel space, in communicably coupled relation with the kernel-level components, to selectively encrypt and decrypt communications between the kernel-level components and a remote site;
(b) disposing a transport module in the kernel space, in communicably coupled relation with the authentication module, to selectively transmit and receive the communications; and
(c) selectively actuating the authentication module and the transport module to convey the communications to and from the kernel-level components.

2. The method of claim 1, comprising the step of communicably coupling the remote site to the kernel-level device by a network, and conveying the communications between the remote site and the kernel-level components while maintaining the communications free from the user space.

3. The method of claim 1, wherein the remote site is disposed within the user space of the computer system, and the communications pass from user space to the kernel-level components while encrypted.

4. The method of claim 1, further comprising the step of (d) disposing a filter driver in the kernel space in communicably coupled relation with the kernel-level components to intercept and selectively permit and prevent the communications from flowing to and from the kernel-level components.

5. The method of claim 4, comprising the steps of sequentially receiving communications from the remote site with the transport module, decrypting the communications with the authentication module, and alternatively permitting and preventing the communications from reaching the kernel-level components with the filter driver.

6. The method of claim 4, comprising the steps of sequentially actuating the filter driver to permit communications to pass from the kernel-level components, encrypting the communications with the authentication module, and transmitting the communications with the transport module.

7. The method of claim 4, further comprising the step of (e) providing a management module to selectively actuate the filter driver, the authentication module, and the transport module to convey the communications to and from the kernel-level components.

8. The method of claim 7, comprising the step of disposing the management module in the kernel space.

9. The method of claim 1, wherein the transport module comprises a kernel sockets module and a communication server, the kernel sockets module and the communication server being disposed within the kernel space.

10. The method of claim 4, further comprising the steps of:
(f) providing a service context module to define a plurality of operational states in which the computer may perform a plurality of operations; and
(g) configuring the filter driver to selectively permit and prevent the performance of the operations by permitting and preventing communications pertaining to the operations when the computer system is disposed in each of the operational states, wherein at least one of the plurality of operations is permitted when the computer system is disposed in a first one of the operational states and prevented when the computer system is disposed in a second one of the operational states.

11. The method of claim 10, wherein the plurality of states comprise an operational state and an administrative state.

12. The method of claim 10, further comprising the step of using a user interface to selectively place the computer system into one of the states.

13. The method of claim 12, wherein the user interface effects the using a user interface step, using encrypted communication with a service context manager disposed in the kernel space.

14. A method of providing secure communication with kernel-level components of a computer system having an operating system that includes user space and kernel space, said method comprising the steps of:
(a) disposing a filter driver in the kernel space to selectively permit and prevent communications with the kernel-level components;
(b) disposing an authentication module in the kernel space, in communicably coupled relation with the filter driver, to selectively encrypt and decrypt the communications; and
(c) disposing a transport module in the kernel space, in communicably coupled relation with the authentication module, to selectively transmit and receive the communications;
(d) actuating the filter driver, authentication module, and transport module to respectively convey received and transmitted communications to and from the kernel-level components.

15. A system for providing secure communication between a remote site and kernel-level components of a computer having user space and kernel space, the system comprising:
a filter driver disposed in the kernel space to selectively permit and prevent communications with the kernel-level components;
an authentication module disposed in the kernel space, in communicably coupled relation with the filter driver, to selectively encrypt and decrypt the communications;
a transport module disposed in the kernel space, in communicably coupled relation with the authentication module, to selectively transmit and receive the communications; and
a remote authentication module disposed in the remote site, in communicably coupled relation with the transport module, to selectively decrypt and encrypt the communications in cooperation with the authentication module;
wherein communications from the remote site to the kernel-level components are sequentially encrypted by the remote authentication module, received by the transport module, decrypted by the authentication module, and selectively permitted to reach the kernel-level components by the filter driver, and communications generated by the kernel-level components are sequentially permitted by the filter driver, encrypted by the authentication module, transmitted by the transport module, and decrypted by the remote authentication module.

16. The system of claim 15, wherein the remote site is discrete from the computer and the communications are conveyed between the remote site and the kernel-level components while being free from the user space.

17. The system of claim 15, wherein the remote site is disposed within the user space of the computer and the communications are conveyed between the user space and the kernel-level components while encrypted.

18. An article of manufacture for providing secure communications with kernel-level components of a computer system having an operating system that includes user space and kernel space, said article of manufacture comprising:
a computer usable medium having computer readable program code embodied therein, said computer usable medium having:
computer readable program code for defining an authentication module in the kernel space, in communicably coupled relation with the kernel-level components, to selectively encrypt and decrypt communications between the kernel-level components and a remote site;
computer readable program code for defining a transport module in the kernel space, in communicably coupled relation with the authentication module, to selectively transmit and receive the communications; and
computer readable program code for selectively actuating the authentication module and the transport module to convey the communications to and from the kernel-level components.

19. Computer readable program code for providing secure communications with kernel-level components of a computer system having an operating system that includes user space and kernel space, said computer readable program code comprising:
computer readable program code for defining an authentication module in the kernel space, in communicably coupled relation with the kernel-level components, to selectively encrypt and decrypt communications between the kernel-level components and a remote site;
computer readable program code for defining a transport module in the kernel space, in communicably coupled relation with the authentication module, to selectively transmit and receive the communications; and
computer readable program code for selectively actuating the authentication module and the transport module to convey the communications to and from the kernel-level components.

20. The computer readable program code of claim 19, comprising computer readable program code for intercepting communications from the remote site to destinations within kernel space and selectively permitting and preventing the communications from reaching the destinations.

21. The computer readable program code of claim 20, comprising one or more shims disposed within the kernel space to intercept the communications.

22. The computer readable program code of claim method of claim 19, comprising computer readable program code for using encrypted communications to selectively place the computer system into one of said states.
